(19) United States
(12) Patent Application Publication
(10) Pub. No.: US 2016/0285135 A1
(43) Pub. Date: Sep. 29, 2016

(54) LITHIUM-SULFUR SECONDARY BATTERY

(71) Applicant: ULVAC, INC., Kanagawa (JP)

(72) Inventors: Naoki Tsukahara, Kanagawa (JP); Yoshiaki Fukuda, Kanagawa (JP); Tatsuhiro Nozue, Kanagawa (JP); Hirohiko Murakami, Kanagawa (JP)

(73) Assignee: ULVAC, INC., Kanagawa (JP)

(21) Appl. No.: 15/032,830

(22) PCT Filed: Oct. 15, 2014
(86) PCT No.: PCT/JP2014/005224

§ 371 Date: Apr. 28, 2016

(30) Foreign Application Priority Data
Dec. 3, 2013 (JP) 2013-249941

(51) Int. Cl. H01M 10/39; H01M 4/70; H01M 4/58; H01M 4/66; H01M 2/16; H01M 4/40

(52) U.S. Cl. CPC H01M 10/399; H01M 2/1686; H01M 4/405; H01M 4/5815; H01M 4/663; H01M 4/70; H01M 2004/028

(57) ABSTRACT

Provided is a lithium-sulfur secondary battery capable of suppressing diffusion of a polysulfide eluted into an electrolyte, into a negative electrode and capable of suppressing lowering of a charge-discharge efficiency. In a lithium-sulfur secondary battery (B) of the invention, having a positive electrode (P) including a positive electrode active material containing sulfur, a negative electrode (N) including a negative electrode active material containing lithium, and a separator (5) which is disposed between the positive electrode and the negative electrode and which allows a lithium ion of an electrolyte (L) to pass therethrough, a cation-exchange membrane (CE) is formed on one of a positive electrode-side surface of the separator and a negative electrode-side surface thereof.

### TECHNICAL FIELD

The present invention relates to a lithium-sulfur secondary battery.

### BACKGROUND ART

Since a lithium secondary battery has a high energy density, an application range thereof is not limited to a handheld equipment such as a mobile phone or a personal computer, but is expanded to a hybrid automobile, an electric automobile, an electric power storage system, and the like. Among these secondary batteries, attention has been recently paid to a lithium-sulfur secondary battery for charging and discharging through a reaction between lithium and sulfur. For example, there is known, e.g., in Patent Document 1 a lithium-sulfur secondary battery including a positive electrode including a positive electrode active material containing sulfur, a negative electrode including a negative electrode active material containing lithium, and a separator which is disposed between the positive electrode and the negative electrode and which allows a lithium ion to pass therethrough.

On the other hand, there is known, e.g., in Patent Document 2 a positive electrode in which a plurality of carbon nanotubes are disposed on a surface of a current collector of the positive electrode so as to be oriented in a direction perpendicular to the surface of the current collector and in which a surface of each of the carbon nanotubes is covered with sulfur in order to increase the amount of sulfur to contribute to a battery reaction.

Here, in a positive electrode of a lithium-sulfur secondary battery, a polysulfide is generated during a reaction between sulfur and lithium through multiple stages. The polysulfide (particularly, Li₂S₆ or Li₂S₄) is eluted into an electrolyte easily, and the eluted polysulfide is diffused as an anion. In the above-mentioned Patent Document 1, the separator is formed of a polymer nonwoven fabric or a porous film made of resin. According to this arrangement, an anion of a polysulfide passes through such a separator and is diffused into a negative electrode. By a reaction of the polysulfide with lithium in the negative electrode, a charge reaction is not accelerated (a so-called redox-shuttle phenomenon occurs), and a charge-discharge capacity and a charge-discharge efficiency are lowered.

### PRIOR ART DOCUMENT

### Patent Documents

Patent Document 1: JP 2013-114920 A

Patent Document 2: WO 2012/070184 A

### SUMMARY OF THE INVENTION

### Problems to be Solved by the Invention

In view of the above points, it is a problem of the invention to provide a lithium-sulfur secondary battery which is capable of suppressing diffusion of a polysulfide eluted into an electrolyte, into a negative electrode and which is capable of suppressing lowering of a charge-discharge capacity and a charge-discharge efficiency.

### Means for Solving the Problems

In order to solve the above problems, this invention is a lithium- sulfur secondary battery comprising: a positive electrode including a positive electrode active material containing sulfur; a negative electrode including a negative electrode active material containing lithium; and a separator which is disposed between the positive electrode and the negative electrode and which allows a lithium ion of an electrolyte to pass therethrough. In the above arrangement, the invention is characterized in that a cation-exchange membrane is formed on at least one of a positive electrode-side surface of the separator and a negative electrode-side surface of the separator.

According to the invention, the cation-exchange membrane formed on the surface of the separator is negatively charged by an anion group contained in the membrane. This allows passing of a lithium ion (cation) and suppresses passing of a polysulfide (anion). This can suppress arrival of a polysulfide eluted into an electrolyte at a negative electrode (that is, can suppress occurrence of a redox-shuttle phenomenon), and can suppress lowering of a charge-discharge capacity and a charge-discharge efficiency.

In the invention, the cation-exchange membrane is preferably selected from a perfluorosulfonic acid polymer, an aromatic polyether polymer, and a hydrocarbon block copolymer containing a hydrophobic segment containing no sulfonic acid group and a hydrophilic segment containing a sulfonic acid group. When the cation-exchange membrane is a hydrocarbon block copolymer, the hydrophobic segment is preferably formed of a polyether sulfone or a polyether ketone, and the hydrophilic segment is preferably formed of a sulfonated polyether sulfone or a sulfonated polyether ketone.

The invention is preferably applied to a positive electrode including:a current collector; a plurality of carbon nanotubes which are grown on a surface of the current collector such that the current collector-surface side serves as a base end and so as to be oriented in a direction perpendicular to the surface of the current collector; and sulfur covering a surface of each of the carbon nanotubes. In this case, the amount of sulfur impregnated in the positive electrode is larger, and a polysulfide is dissolved into an electrolyte more easily than a positive electrode in which sulfur is applied on a surface of a current collector. However, by application of the invention, elution of the polysulfide into a negative electrode can be suppressed effectively.

### BRIEF DESCRIPTION OF DRAWINGS

FIG. 1 is a schematic cross sectional view illustrating a structure of a lithium-sulfur secondary battery according to an embodiment of the invention.

FIG. 2 is an enlarged schematic cross sectional view illustrating the positive electrode in FIG. 1.

FIG. 3 is a graph indicating an experimental result (charge-discharge curve) for confirming an effect of the invention.

FIG. 4 is a graph indicating an experimental result (charge-discharge capacity and charge-discharge efficiency) for confirming the effect of the invention.

### MODES FOR CARRYING OUT THE INVENTION

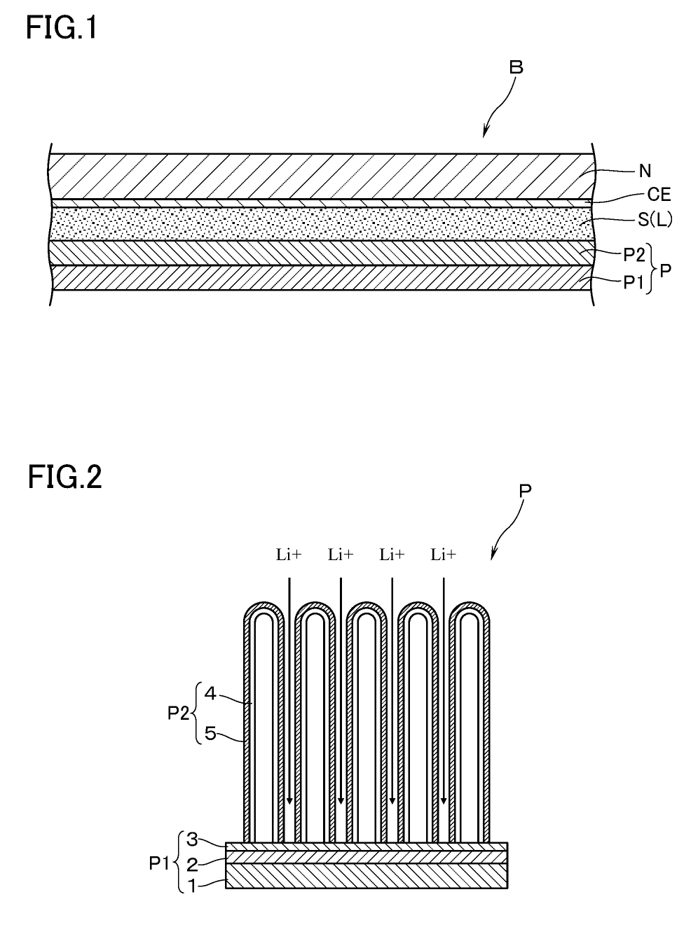

In FIG. 1, the reference mark B represents a lithium-sulfur secondary battery. The lithium-sulfur secondary battery B includes a positive electrode P containing a positive electrode active material containing sulfur, a negative electrode N containing a negative electrode active material containing lithium, and a separator S which is disposed between the positive electrode P and the negative electrode N and which allows a lithium ion of an electrolyte L to pass therethrough.

With reference also to FIG. 2, the positive electrode P includes a positive electrode current collector P1 and a positive electrode active material layer P2 formed on a surface of the positive electrode current collector P 1. The positive electrode current collector P1 includes, for example, a substrate 1, an underlying film (also referred to as “a barrier film”) 2 formed on a surface of the substrate 1 to a film thickness of 5 to 50 nm, and a catalyst layer 3 formed on the underlying film 2 to a film thickness of 0.5 to 5 nm. As the substrate 1 there may be used, for example, a metal foil or a metal mesh made of Ni, Cu, or Pt. The underlying film 2 is used for improving adhesion between the substrate 1 and carbon nanotubes 4 described below. The underlying film 2 is formed, for example, of at least one metal selected from Al, Ti, V, Ta, Mo, and W, or a nitride of the metal. The catalyst layer 3 is formed of at least one metal selected from Ni, Fe, and Co. The positive electrode active material layer P2 is formed: of a plurality of the carbon nanotubes 4 which are grown on the surface of the current collector P1 such that the surface side of the current collector serves as a base end and so as to be oriented in a direction perpendicular to the surface of the current collector; and of sulfur 5 which covers the surface of each of the carbon nanotubes 4, respectively. There is a gap between the respectively adjacent carbon nanotubes 4 covered with the sulfur 5, and the electrolyte L described below is arranged to flow into this gap.

Here, in consideration of a battery characteristic, each of the carbon nanotubes 4 is advantageous to have a high aspect ratio in the range of 100 to 1000 μm in length and in the range of 5 to 50 nm in diameter, and it is preferable to grow the carbon nanotubes 4 so as to have the density per unit area in the range of 1×10¹⁰ to 1×10¹² tubes/cm². The sulfur 5 covering the entire surface of each of the carbon nanotubes 4 preferably has a thickness, for example, in the range of 1 to 3 nm.

The positive electrode P can be formed by the following method. That is, the positive electrode current collector P1 is obtained by forming an Al film as the underlying film 2 and a Ni film as the catalyst layer 3 sequentially on a surface of a Ni foil as the substrate 1. As the method of forming the underlying film 2 and the catalyst layer 3, there can be used, for example, a known electron beam vapor deposition method, sputtering method, or dipping method using a solution of a compound containing a catalyst metal. Therefore, detailed description thereof is omitted here. The resulting positive electrode current collector P1 is disposed in a processing chamber of a known CVD apparatus, a mixed gas containing a raw material gas and a diluent gas is supplied into the processing chamber at an operation pressure of 100 Pa to an atmospheric pressure, and the positive electrode current collector P1 is heated to a temperature of 600 to 800° C. In this way, the carbon nanotubes 4 are grown on a surface of the current collector P1 so as to be oriented in a direction perpendicular to the surface. As a CVD method for growing the carbon nanotubes 4, a thermal CVD method, a plasma CVD method, or a hot filament CVD method can be used. As the raw material gas there can be used, for example, a hydrocarbon such as methane, ethylene or acetylene, or an alcohol such as methanol or ethanol. As the diluent gas there can be used nitrogen, argon, or hydrogen. The flow rates of the raw material gas and the diluent gas can be set appropriately depending on the capacity of the processing chamber. For example, the flow rate of the raw material gas can be set within a range of 10 to 500 sccm, and the flow rate of the diluent gas can be set within a range of 100 to 5000 sccm. Granular sulfur having a particle diameter of 1 to 100 μm is sprayed from above over an entire area in which the carbon nanotubes 4 have been grown. The positive electrode current collector P1 is disposed in a tubular furnace, and is heated to a temperature of 120 to 180° C. equal to or higher than the melting point of sulfur (113° C.) to melt the sulfur. If sulfur is heated in the air, the melted sulfur reacts with water in the air to generate sulfur dioxide. Therefore, it is preferable to heat sulfur in an inert gas atmosphere such as Ar, or He, or in vacuo. The melted sulfur flows into the gap between the respectively adjacent carbon nanotubes 4, and the entire surface of each of the carbon nanotubes 4 is covered with the sulfur 5 with a gap between the respectively adjacent carbon nanotubes 4 (see FIG. 2). At this time, the weight of sulfur disposed as described above can be set depending on the density of the carbon nanotubes 4. For example, in a case where the growing density of the carbon nanotubes 4 is 1×10¹⁰ to 1×10¹² tubes/cm², the weight of sulfur is preferably set to a value that is 0.7 to 3 times the weight of the carbon nanotubes 4. The positive electrode P formed in this way will have the weight of the sulfur 5 (impregnation amount) per unit area of the carbon nanotubes 4 of 2.0 mg/cm² or more.

Examples of the negative electrode N include, aside from 0000a Li simple substance, an alloy of Li and Al or In, and Si, SiO, Sn, SnO₂, and hard carbon doped with lithium ions.

The separator S is formed of a porous film or a nonwoven fabric made of a resin such as polyethylene or polypropylene, and is arranged to be able of holding the electrolyte L. It is so arranged that a lithium ion (Li⁺) can be transmitted between the positive electrode P and the negative electrode N via the electrolyte L. The electrolyte L contains an electrolyte and a solvent for dissolving the electrolyte. Examples of the electrolyte include well-known lithium bis(trifluorometalsulfonyl)imide (hereinafter, referred to as “LiTFSI”), LiPF₆, and LiBF₄. As the solvent, a known solvent can be used, and for example, at least one selected from ethers such as tetrahydrofuran, glyme, diglyme, triglyme, tetraglyme, diethoxyethane (DEE), and dimethoxyethane (DME), and esters such as diethyl carbonate and propylene carbonate can be used. In order to stabilize a discharge curve, it is preferable to mix dioxolane (DOL) to the at least one selected. For example, when a mixed liquid of diethoxy ethane and dioxolane is used as a solvent, the mixing ratio between diethoxyethane and dioxolane can be set to 9:1.

Here, in the positive electrode P, a polysulfide is generated during a reaction between sulfur and lithium through multiple steps. The polysulfide (particularly, Li₂S₄ or Li₂S₆) is eluted into an electrolyte L easily, and the eluted polysulfide is diffused as an anion. The separator S allows the anion of the polysulfide to pass therethrough. Therefore, arrival of the anion which has passed through the separator S at the negative electrode causes a redox-shuttle phenomenon, and a charge-discharge capacity or a charge-discharge efficiency is lowered. Therefore, how to suppress the reaction between the polysulfide and Li is important.

Therefore, according to the present embodiment, a cation-exchange membrane CE was formed on a negative electrode N-side surface of the separator S. The cation-exchange membrane CE has an anion group, and therefore is charged negatively. The negatively charged cation-exchange membrane CE allows passing of a lithium ion (cation) and suppresses passing of a polysulfide (anion). This can suppress arrival of the polysulfide eluted into the electrolyte L at the negative electrode N, that is, can suppress occurrence of a redox-shuttle phenomenon, and therefore can suppress lowering of a charge-discharge capacity and a charge-discharge efficiency.

The cation-exchange membrane CE can be selected from a perfluorosulfonic acid polymer such as polytetrafluoroethylene perfluoro sulfonic acid, an aromatic polyether polymer, and a hydrocarbon block copolymer containing a hydrophobic segment containing no sulfonic acid group and a hydrophilic segment containing a sulfonic acid group. When the cation-exchange membrane CE is a hydrocarbon block copolymer, the hydrophobic segment is preferably formed of a polyether sulfone or a polyether ketone, and the hydrophilic segment is preferably formed of a sulfonated polyether sulfone or a sulfonated polyether ketone. The cation-exchange membrane CE can be formed by a well-known coating method. Therefore, detailed conditions thereof are not described here.

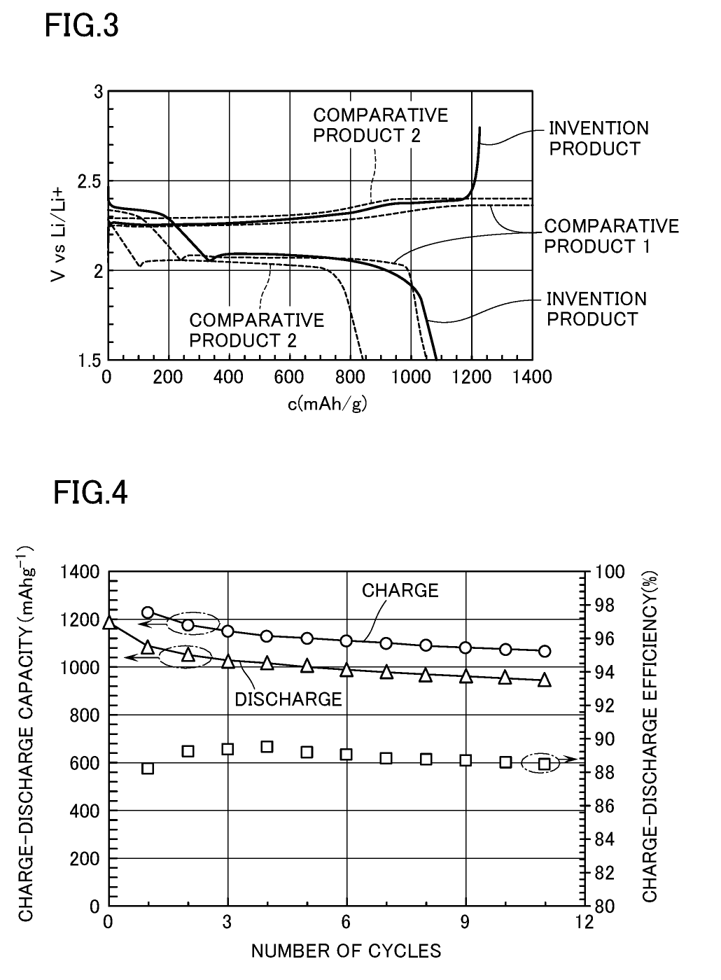

Next, an experiment was performed in order to confirm an effect of the invention. In the present experiment, first, the positive electrode P was manufactured as follows. That is, a Ni foil having a diameter of 14 mmφ and a thickness of 0.020 mm was used as the substrate 1. An Al film having a thickness of 30 nm as the underlying film 2 was formed on the Ni foil 1 by an electron beam evaporation method, and an Fe film having a thickness of 1 nm as the catalyst layer 3 was formed on the Al film 2 by an electron beam evaporation method to obtain the positive electrode current collector P 1. The resulting positive electrode current collector P1 was disposed in a processing chamber of a thermal CVD apparatus. Then, while acetylene at 15 sccm and nitrogen at 750 sccm were supplied into the processing chamber, the carbon nanotubes 4 were grown on the surface of the positive electrode current collector P1 so as to be oriented perpendicularly and so as to have a length of 800 μm at an operation pressure of 1 atmospheric pressure at a temperature of 750° C. in a growing time of 10 minutes. Granular sulfur was placed on the carbon nanotubes 4. The resulting carbon nanotubes 4 were disposed in a tubular furnace, and were covered with the sulfur 5 by heating the carbon nanotubes 4 to 120° C. for five minutes in an Ar atmosphere. The positive electrode P was thereby manufactured. In the positive electrode P, the weight (impregnation amount) of the sulfur 5 per unit area of the carbon nanotubes 4 was 3 mg/cm². Tetrafluoroethylene perfluoro sulfonic acid (trade name “5% Nafion dispersion solution DE521” manufactured by Wako Pure Chemical Industries, Ltd.) was applied to the surface of the separator S formed of a porous film made of polypropylene, and was dried at 60° C. for 60 minutes. The cation-exchange membrane CE having a thickness of 500 nm was thereby formed. As the negative electrode N, an electrode having a diameter of 15 mmφ and a thickness of 0.6 mm and made of metal lithium was used. The positive electrode P and the negative electrode N were disposed so as to face each other through the separator S, and the separator S was made to hold the electrolyte L. A coin cell of a lithium-sulfur secondary battery was thereby formed. Here, as the electrolyte L, a solution obtained by dissolving LiTFSI as an electrolyte in a mixed liquid (mixing ratio 9:1) of diethoxy ethane (DEE) and dioxolane (DOL) and adjusting the concentration to 1 mol/l was used. The coin cell that was manufactured in this way was referred to as an invention product. Except that the cation-exchange membrane CE was not formed, a coin cell that was manufactured in a manner similar to the above invention product was referred to as comparative product 1. Further, except that a polyvinylidene fluoride film was formed in place of the cation-exchange membrane CE, a coin cell that was manufactured in a manner similar to the above invention product was referred to as comparative product 2. Charge and discharge were performed on each of the invention product and comparative products 1 and 2. FIG. 3 illustrates charge-discharge curves thereof. According to these curves, it has been confirmed that charge was not completed due to a redox-shuttle phenomenon in comparative products 1 and 2. On the other hand, it has been found that charge was completed and that a redox-shuttle phenomenon can be suppressed in the invention product. In addition, it has been confirmed that the invention product can obtain a higher discharge capacity than comparative products 1 and 2.

Next, the charge-discharge capacity and the charge-discharge efficiency of the invention product were measured. Measurement results thereof are illustrated in FIG. 4. According to these results, it has been confirmed that a high charge capacity of 1000 mAh/g or more and a high discharge capacity of 900 mAh/g can be realized, and a high charge-discharge efficiency of 88% or more can be obtained even at the 11th cycle.

A coin cell manufactured in a manner similar to the above invention product except that a cation-exchange membrane was formed on a separator S-side surface of the positive electrode P in place of forming a cation-exchange membrane on a surface of the separator S, was referred to as comparative product 3. Charge and discharge were performed on this comparative product 3. It has been confirmed that charge is completed but that a charge capacity is as low as 600 mAh/g (500 mAh/g at the 10th cycle). It is considered that this is because the surface of the positive electrode P (surface of growing end of the carbon nanotubes) has large irregularities and because, as a consequence, a cation-exchange membrane cannot be formed over the entire surface of the growing end of the carbon nanotubes.

Hereinabove, the embodiment of the invention has been described. However, the invention is not limited to those described above. The shape of the lithium-sulfur secondary battery is not particularly limited, and may be a button type, a sheet type, a laminate type, a cylinder type, or the like in addition to the above-mentioned coin cell. Further, in the above embodiment, the cation-exchange membrane CE was formed on the negative electrode N-side surface of the separator S. However, a cation-exchange membrane may be formed on a positive electrode P-side surface of the separator S, or on both of the negative electrode N-side surface of the separator S and the positive electrode P-side surface thereof.

### EXPLANATION OF REFERENCE MARKS

B lithium-sulfur secondary battery

P positive electrode

N negative electrode

L electrolyte

CE cation-exchange membrane

P1 current collector

1 substrate

4 carbon nanotube

5 sulfur

1. A lithium-sulfur secondary battery comprising:
a positive electrode including a positive electrode active material containing sulfur;
a negative electrode including a negative electrode active material containing lithium; and
a separator which is disposed between the positive electrode and the negative electrode and which allows a lithium ion of an electrolyte to pass therethrough,
characterized in that a cation-exchange membrane is formed on at least one of a positive electrode-side surface of the separator and a negative electrode-side surface of the separator.

2. The lithium-sulfur secondary battery according to claim 1, wherein
the cation-exchange membrane is selected from a perfluorosulfonic acid polymer, an aromatic polyether polymer, and a hydrocarbon block copolymer containing a hydrophobic segment containing no sulfonic acid group and a hydrophilic segment containing a sulfonic acid group.

3. The lithium-sulfur secondary battery according to claim 2, wherein
the hydrophobic segment is formed of a polyether sulfone or a polyether ketone, and
the hydrophilic segment is formed of a sulfonated polyether sulfone or a sulfonated polyether ketone.

4. The lithium-sulfur secondary battery according to claim 1, wherein
the positive electrode includes:
a current collector;
a plurality of carbon nanotubes which are grown on a surface of the current collector such that the current collector-surface side serves as a base end and so as to be oriented in a direction perpendicular to the surface of the current collector; and
sulfur covering a surface of each of the carbon nanotubes.

5. The lithium-sulfur secondary battery according to claim 2, wherein
the positive electrode includes:
a current collector;
a plurality of carbon nanotubes which are grown on a surface of the current collector such that the current collector-surface side serves as a base end and so as to be oriented in a direction perpendicular to the surface of the current collector; and
sulfur covering a surface of each of the carbon nanotubes.

6. The lithium-sulfur secondary battery according to claim 3, wherein
the positive electrode includes:
a current collector;
a plurality of carbon nanotubes which are grown on a surface of the current collector such that the current collector-surface side serves as a base end and so as to be oriented in a direction perpendicular to the surface of the current collector; and
sulfur covering a surface of each of the carbon nanotubes.

7. The lithium-sulfur secondary battery according to claim 2, wherein the cation-exchange membrane is polytetrafluoroethylene perfluoro sulfonic acid.
